(19) United States
(12) Patent Application Publication
(10) Pub. No.: US 2024/0092032 A1
(43) Pub. Date: Mar. 21, 2024

(54) STRUCTURAL SUPPORTS FOR ADDITIVELY MANUFACTURED ARTICLES

(71) Applicant: OPT Industries, Inc., Medford, MA (US)

(72) Inventors: Kai-Hong Anthony Chu, Cambridge, MA (US); Neil Grewal, Boston, MA (US); Zongheng Sun, Cambridge, MA (US); Jifei Ou, Medford, MA (US)

(73) Assignee: OPT Industries, Inc., Medford, MA (US)

(21) Appl. No.: 18/467,879

(22) Filed: Sep. 15, 2023

Related U.S. Application Data
(60) Provisional application No. 63/407,323, filed on Sep. 16, 2022.

(51) Int. Cl. B29C 64/40; B29C 64/393

(52) U.S. Cl. CPC B29C 64/40; B29C 64/393; B33Y 10/00

(57) ABSTRACT

Provided herein are methods for supporting a 3D-printed article while it is being produced. The methods can include printing the support structure along with the article, where the article can be removed from the support structure after the production process. In some embodiments, a method includes: determining a concave hull from an article to be 3D-printed, wherein the article to be 3D-printed comprises a plurality of fibers; determining one or more support pillars for connecting the article to be 3D-printed and a support surface; and printing the one or more support pillars and the article to be 3D-printed together using a 3D printing method. Also provided herein are methods for determining the geometry of the support structure and the supported 3D-printed article produced by the methods described herein.

### CROSS-REFERENCE TO RELATED APPLICATIONS

This application claims the benefit under 35 U.S.C. § 119(e) of U.S. Provisional Application No. 63/407,323, filed Sep. 16, 2022, and entitled “STRUCTURAL SUPPORTS FOR ADDITIVELY MANUFACTURED ARTICLES,” the entire contents of which are incorporated herein by reference.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### FIELD

The technologies relate to 3D-printing systems and methods, and more particularly to systems and methods for producing supported 3D-printed articles with complex geometry.

### BACKGROUND

Additive manufacturing technology, also known as 3D printing, allows for the manufacture of finished products with complex geometries that are difficult or impossible to make with other technologies. High-resolution stereolithography 3D printing, such as Digital Light Processing (DLP) printing technology, can allow printing resolutions of less than 100 micrometers (um). High-resolution 3D printing enables producing intricate structures to reduce object weight, construct metamaterials, realize biomimicry design or achieve aesthetic surface textures.

### SUMMARY

The methods and articles described herein present a solution to new problems that have been recognized by the present inventors. Counter-intuitively, these new problems are a result of the aforementioned advances in high-resolution 3D printing. Namely, producing intricate structures with fine (e.g., thin) features with a high degree of reproducibility and quality, and for low cost can require optimal utilization of the 3D printing system from a time and materials perspective. Furthermore, the printed article can require a physical support structure to protect it or retain its geometry through the printing and post-production process. Existing technologies for supporting 3D printed articles do not adequately address these technical challenges. For example, printing an overly robust support structure can protect the article through post-processing, but is overly costly to print with respect to time and materials. Conversely, a sparse yet economic support may not protect the geometry of the article through the printing process.

The methods and support structures described herein can provide a high-quality and low-cost 3D-printed article having fine features. Such articles can include textiles, feathers, fur, brushes, foams, or any other fibrous or finely-featured object.

In an aspect, the techniques provide a supported 3D-printed article. The supported 3D-printed article includes: a 3D-printed article comprising a plurality of fibers; a support surface; and one or more support pillars connecting the 3D-printed article to the support surface to provide support for the 3D-printed article. The 3D-printed article defines a concave hull, where the concave hull comprises one or more vertices thereon respectively connecting the one or more support pillars.

In an aspect, the techniques provide a computerized method for producing a supported 3D-printed article. The method includes: determining a concave hull from an article to be 3D-printed, wherein the article to be 3D-printed comprises a plurality of fibers; determining one or more support pillars for connecting the article to be 3D-printed and a support surface; and printing the one or more support pillars and the article to be 3D-printed together using a 3D printing method.

In an aspect, the techniques provide a system for producing a supported 3D-printed article. The system includes: a 3D printer; and one or more processors configured to: determine a concave hull from an article to be 3D-printed, the article to be 3D-printed comprising a plurality of fibers; determine one or more support pillars for connecting the article to be 3D-printed and a support surface based on the concave hull; and cause the 3D printer to print the one or more support pillars and the article to be 3D-printed together using a 3D printing method.

In an aspect, the techniques provide a computerized method for determining a support structure for producing a supported 3D-printed article. The method includes: determining a concave hull from an article to be 3D-printed, the article to be 3D-printed comprising a plurality of fibers; and determining one or more support pillars for connecting the article to be 3D-printed and a support surface based on the concave hull.

In an aspect, the techniques provide a supported 3D-printed mascara brush, which includes: a 3D-printed article comprising a plurality of bristles; a support surface; a cocoon support surrounding the plurality of bristles and connecting to the plurality of bristles via a plurality of first support pillars; and a plurality of second support pillars connecting the cocoon support and the support surface.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF FIGURES

The patent or application file contains at least one drawing executed in color. Copies of this patent or patent application publication with color drawing(s) will be provided by the Office upon request and payment of the necessary fee.

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1 shows an example of a system for printing from the bottom-up through a transparent window.

FIG. 2 shows an example of a system for printing from the top-down.

FIG. 3 shows an example of a system for printing on a pliable substrate.

FIG. 4 shows an example of the principal components of the support system described herein.

FIG. 5A shows an example of the principal steps of the method for determining the support system described herein, according to some embodiments.

FIG. 5B is a flow chart of an example computerized method for printing a supported 3D printed article, according to some embodiments.

FIG. 6A shows examples of breakpoint designs suitable for removing the printed article from the mechanical supports, according to some embodiments.

FIG. 6B shows an example of a variation of a ball breakpoint before and after being partially cured, according to some embodiments.

FIG. 7 shows an example of the method for determining coincident vertices described herein, according to some embodiments.

FIG. 8 shows an example schematic illustration of principal steps for determining a support structure for a printed article, according to some embodiments.

FIG. 9 shows examples of applying the methods and support structures described herein, according to some embodiments.

FIG. 10 shows an example of support of a mascara brush as described herein, according to some embodiments.

FIG. 11 shows a second schematic drawing of an example of the present disclosure for supporting a mascara brush, according to some embodiments.

FIG. 12 shows an example of the calculation of input constraints for determination of a tetrahedral plate support, according to some embodiments.

FIG. 13 shows an example of steps for calculation of the geometry of a tetrahedral plate support, according to some embodiments.

FIG. 14 shows an example of further steps for calculation of the geometry of a tetrahedral plate support, according to some embodiments.

### DESCRIPTION

Additive manufacturing technology, also known as 3D printing, is a manufacturing method that utilizes the instrument to manufacture finished “additive” products with complex geometries that can be difficult or impossible to make with other conventional manufacturing methods such as molding (inject and transfer molding, etc.) and subtractive manufacturing (laser cutting and milling, etc.). Additive manufacturing methods can have extensive advantages over conventional methods. First, it allows for manufacture parts with highly intricate shapes and internal lattice structures. Second, it generates little waste and has high starting material utilization, especially in comparison with subtractive manufacturing such as milling. Third, it enables fast production with little lead time and low tooling cost. This can be especially true compared to molding methods which need to make molds before the desired parts are fabricated using the molds. Fourth, it enables on-demand fabrication of parts in small quantities without having to prepare expensive molds beforehand. It can also allow easy modification based on the fabricated part evaluation and is highly useful for prototyping. Overall, additive manufacturing methods can have extensive advantages over conventional manufacturing practices in many aspects.

Additive manufacturing methods can be categorized based on the materials or by technology used. Material selection for printing, includes, but is not limited to, thermoplastic and thermoset polymers, photopolymers (photo-monomers/oligomers to be exact), metals, ceramics, (hydro)gels, paste, sand, composites, etc. Common 3D printing methods include fused deposition modeling (FDM, also known as FFF, fused filament fabrication), digital light processing (DLP), stereolithography (SLA), selective laser sintering (SLS), directed energy deposition (DED), direct ink writing (DIW), and binder jetting (BJ). FDM/FFF, SLS, and SLA/DLP are by far the most popular and the three main printing techniques in use.

Materials for the additive manufacturing can utilize a multitude of polymerization techniques to create 3D articles with desirable material performance properties for end-use applications. These polymerization reactions are typically initiated with UV radiation that is directed at portions of a solution of polymer precursor. Radiation can be directed (e.g., as an image) on the surface of a volume of solution in proximity to a pliable substrate such that a layer of polymer is deposited on the substrate. The substrate can then be moved further into the solution, a thin layer of polymer precursor can flow to cover the first polymer layer, and a second polymerization can be initiated to print a second layer of polymer onto the first layer. This process can be repeated to print a 3D object.

DLP and SLA are examples of 3D printing techniques suitable for performing the systems and methods described herein (e.g., because UV light or other radiation can result in articles and supports having fine features). SLA and DLP 3D printers can vary regarding how light is projected onto the UV curable polymer resins. Earlier printers generally use SLA based on a laser system that moves around to cure the targeted area pixel by pixel. DLP, however, can cure a whole layer at one time. DLP 3D printers can use a digital projector screen to flash an image of a layer across the entire platform, curing all points in the same layer simultaneously. The light can be reflected on a Digital Micromirror Device (DMD), which is a dynamic mask comprising microscopic-size mirrors laid out in a matrix on a semiconductor chip. Rapidly toggling these tiny mirrors between the lens(es) that direct the light towards the resin can define the coordinates where the liquid resin cures within the given layer. Because the projector is a digital screen, the image of each layer is composed of square pixels, resulting in a three-dimensional layer formed from small rectangular cubes called voxels. This can enable DLP to become one of the fastest 3D printing techniques. Its other advantages include, but are not limited to, relatively low cost, versatile printing polymer selection, high printing resolution, and ease of operation.

DLP can have a selection of polymers and composites to print from including acrylates and methacrylate-functional polymers. UV curable formulations used in the DLP additive manufacturing industry can include ethylenically and/or vinyl-functional (i.e., double bond) oligomers and monomers (e.g., acrylates, methacrylates, vinyl ethers, vinyl carbonates), diluents, chain extenders, photo-initiators, and additives. The oligomers and monomers can provide mechanical properties to the final product upon polymerization. Diluents are used to reduce overall formulation viscosity for ease of processing and handling. Diluents can be reactive and can be incorporated into the polymer matrix of the finished article. Photo-initiators can form free radicals upon exposure to actinic radiation (e.g., through photolytic degradation of the photo-initiator molecule). The free radicals can then initiate and propagate with the vinyl moieties of the oligomers and monomers to form vinyl-based, crosslinked polymers. Additives can include but are not limited to pigments, dyes, UV absorbers, hindered amine light stabilizers, and fillers. Additives can be used to impart useful properties such as color, shelf stability, improved lifetime performance, higher UV stability, etc.

Additive manufacturing has faced several technological challenges, specifically for high-resolution 3D printed microstructures. These challenges include, but are not limited to, slow production speeds, inconsistencies in material development and material properties of 3D printed parts, manual post-processing, limited capabilities in data preparation and design, part-to-part variation, and a lack of digital infrastructure.

To address the above mentioned technical problems and other technical problems, the inventors have developed new technologies to produce supported 3D-printed articles with fine features such as fibers. The support structure strategy described herein for high-resolution 3D printed parts has significantly advanced the field due to improved ability to enhance the printing process and performance thereof for printing 3D articles. In particular, the technologies provide the ability to optimize throughput by nesting operations, support self-intersecting geometries for finer resolution, control resin flow for objects printed using stereolithography, and provide a step-by-step user-designed support removal process to speed up post-production processes.

The methods described herein can be used with any suitable 3D printing system. The photo-curable resin can be any suitable resin that is capable of polymerization when exposed to radiation (e.g., ultraviolet (UV) radiation). The resin can be part of a formulation that can include a photo-initiator, a UV absorber, a pigment, a diluent, and one or more monomers or oligomers. In some cases, UV radiation interacts with the photo-initiator to start a free-radical mediated polymerization of the monomers and/or oligomers.

Following polymerization, the printed article can be removed from the vat of photo-curable resin and washed of residual (non-polymerized) resin. Further processing steps can include washing uncured resin, performing additional curing of the printed resin, or performing a secondary polymerization.

Described herein are various techniques, including systems, computerized methods, and non-transitory instructions that enable printing a supported 3D-printed article. In some embodiments, a method for producing a supported 3D-printed article may include: determining a concave hull from an article to be 3D-printed, wherein the article to be 3D-printed comprises a plurality of fibers; determining one or more support pillars for connecting the article to be 3D-printed and a support surface; and printing the one or more support pillars and the article to be 3D-printed together using a 3D printing method. The 3D printing method may include any suitable printing method, such as FDM/FFF, SLS, or SLA/DLP.

In determining the one or more support pillars, the method may determine vertices on the concave hull that need support and determine support pillars. The support pillars may extend respectively from the vertices that need support to the support surface (e.g., a substrate) in a support direction. In determining the vertices that need support, the method may evaluate a candidate vertex on the concave hull against one or more criteria. For example, the one or more criteria may include an evaluation of a degree of alignment between a vector normal to the concave hull surface at the candidate vertex and the support direction. The degree of alignment may be represented by a dot product between the normal vector and the support direction. If the normal vector and the support direction are sufficiently aligned (e.g., the dot product is below a threshold), the method may determine that the candidate vertex needs support.

In some embodiments, the one or more criteria for evaluating whether a candidate vertex on the concave hull needs support may include determining whether the vertex on the concave hull is a minima point with respect to the support surface and the support direction. In some embodiments, the one or more criteria for evaluating whether a candidate vertex on the concave hull needs support may include evaluating the valency of the candidate vertex. Whereas the 3D-printed article may be represented a plurality of line objects each comprising a plurality of connected nodes, valency may be represented by a number of neighbor nodes to which a point is connected in a line object. If the valency of a candidate vertex is at or below a threshold valency (e.g., one or less), then the method may determine that the candidate vertex needs support.

In some embodiments, the one or more criteria for evaluating whether a candidate vertex on the concave hull needs support may include determining whether a distance between the candidate vertex and a closest vertex on the concave hull (which needs support) is above a threshold distance. If the distance is above a threshold distance, the method may determine that the candidate vertex needs support.

In some embodiments, in determining the vertices on the concave hull that need support, candidate vertices may first be determined. The method may determine a bounding geometry comprising a geometry with least area encompassing the concave hull as if the geometry is vacuum wrapped around the article to be 3D-printed. Candidate vertices may be determined to be coincident vertices on the concave hull and on the bounding geometry.

In some embodiments, the method may further determine one or more breakpoints at ends of the one or more support pillars such that the support pillars may be severed from the 3D-printed article at the one or more breakpoints after printing. A breakpoint may be a tapered tip, a ball tip, or a uniform tip. In some embodiments, the location of a breakpoint may be determined such that the breakpoint is in contact with the 3D-printed article. In some embodiments, the location of a breakpoint may be determined such that the breakpoint (e.g., a ball tip) is in a proximity of and in non-contact with the 3D-printed article. A curing process may be applied to the breakpoint to cause the breakpoint to be partially cured such that the partially cured resin in the breakpoint grows to contact the 3D-printed article to provide support for the 3D-printed article. In non-limiting examples, the partially resin may be a gel.

The methods for producing the supported 3D-printed article as described above and further herein may be used for various printing methods such as FDM/FFF, SLS, or SLA/DLP. The methods may be applied to various configurations of the 3D-printed article. These various configurations may include two 3D-printed articles being proximate to each other such that support pillars may be added between the two articles. In such case, one 3D-printed article may serve as a support for the other 3D-printed article via the support pillars. In some embodiments, a variation of a supported 3D-printed article may include an intermediate support structure (e.g., a cocoon model, a cage model) surrounding the 3D-printed article to provide support for the 3D-printed article, via, for example, additional support pillars. The intermediate support structure may be supported via support pillars that extend from the support surface (e.g., a substrate). An example of a cage model may include a tetrahedral plate.

In some embodiments, another variation of a supported 3D-printed article may include a leading portion connecting to the 3D-printed article, where the leading portion is elevated from the support surface and supported by one or more additional support pillars. This configuration may allow printing in which the printing direction and the resin level are not aligned, e.g., at an angle above 45 degrees relative to each other. In some embodiments, another variation of a supported 3D-printed article may include a support wall connecting and extending perpendicularly from the support surface, wherein the support wall is adjacent to the article to be 3D-printed.

In some embodiments, a supported 3D-printed article that is printed using the methods described above may include: a 3D-printed article comprising a plurality of fibers; a support surface; and one or more support pillars connecting the 3D-printed article to the support surface to provide support for the 3D-printed article. The 3D-printed article defines a concave hull, where the concave hull comprises one or more vertices thereon respectively connecting the one or more support pillars.

As a result, the present methodology alleviates many limitations in existing methods. It allows a decrease in overall density of support which can stabilize the 3D printed article during printing, prevent recoating, increase printing efficiency, and reduce waste. The present method can also support multiple load cases without increasing individual element size, further reducing waste and increasing printing efficiency. Furthermore, as the strategy described herein relies on analyzing a collection of discrete 3D printed parts, the methodology allows for stacked support systems within a defined printed area, providing additional stability and printing precision. The present method can be used to support complex microstructures.

As used herein, the term “3D printed part” or “3D printed article” can mean any geometry that is intended to be fabricated by 3D printing, and in some cases used as an end-product.

As used herein, the term “substrate” can mean a suitable structure, e.g., a layer, made of any suitable material, upon which a 3D printed article rests during the printing process.

As used herein, the term “machined part” can mean any mechanism or object used to make a 3D printer.

As used herein, the term “printed structure” can mean any geometry that is printed before or during the printing of the 3D printed part and intended to be removed from the 3D printed part after the 3D printing process.

As used herein, the term “support surface” can mean any geometry designed to provide support for a 3D printed part during a 3D printing process and be removable from the 3D printed part after 3D printing process.

As used herein, the term “support pillar” can mean a pillar structure used to connect support surfaces to 3D printed parts. The cross-section of a support pillar can be of any suitable shape, such as a circle, a square, or any other shape.

As used herein, the term “brace” can mean a connector used to connect support pillars to adjacent support pillars.

As used herein, the term “breakpoint” can mean a designated point where a support structure can be severed from 3D printed part after the printing process. For example, a breakpoint may be formed at a tip of a support pillar connecting the 3D printed part or any support surface.

As used herein, the term “tapered tip” can mean a support pillar that comprises a variable size, e.g., a variable diameter.

As used herein, the term “ball tip” can mean a support pillar that is spherical in shape.

As used herein, the term “uniform tip” can mean a support pillar that maintains a substantially consistent diameter.

As used herein, the term “concave hull” can mean a geometry that is formed by a set of fibers in a 3D-printed article. For example, a concave hull may be a surface defined by the tips of the fibers in the 3D-printed article. A concave hull can mean an alpha shape that is manifold and solid.

As used herein, the term “bounding geometry” can mean a geometry that encompasses a concave hull.

As used herein, the term “minima” can mean the lowest relative position of a point within Euclidean space.

As used herein, the term “dot product” can mean the product of the Euclidean magnitudes of the two vectors and the cosine of the angle between them.

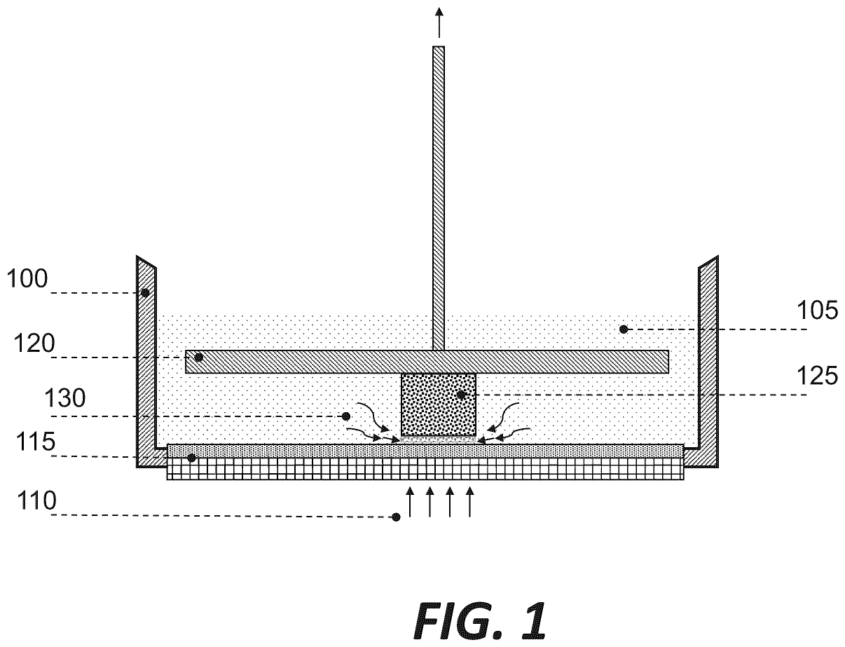

The methods described herein can be performed with any suitable 3D printing hardware (e.g., having digital light processors). FIGS. 1-3 show suitable systems for 3D printing. As seen in FIG. 1, printing can be performed from the bottom-up through a transparent window. Here, a container 100 can include a volume of photo-curable resin 105. UV light 110 can be projected through a glass plate or lens 115 onto a building platform 120. This can initiate polymerization into a cured article 125. The building platform can be moved upward, which can cause non-cured resin to flow and recoat 130 the printed article with resin such that a subsequent layer of the article can be printed.

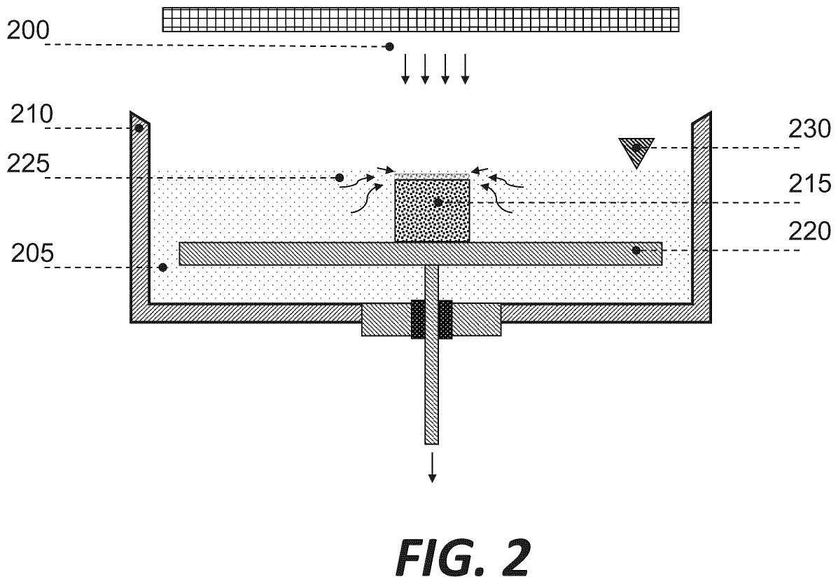

Similarly, FIG. 2 shows an example of a system for printing from the top-down. UV light 200 can be projected from the top-down onto an open surface of photocurable resin 205 that is contained in a vat 210. The cured article 215 can be printed onto a building platform 220 which can be moved downward into the vat of resin after each print layer. This can result in un-cured resin flowing 225 onto the surface of the cured article, which can be subsequently exposed to radiation to print another layer of the printed article. In some instances, this re-flow of resin is a rate limiting step of the overall process. Therefore, a recoating mechanism 230 (e.g., mechanical arm) can assist the recoating process.

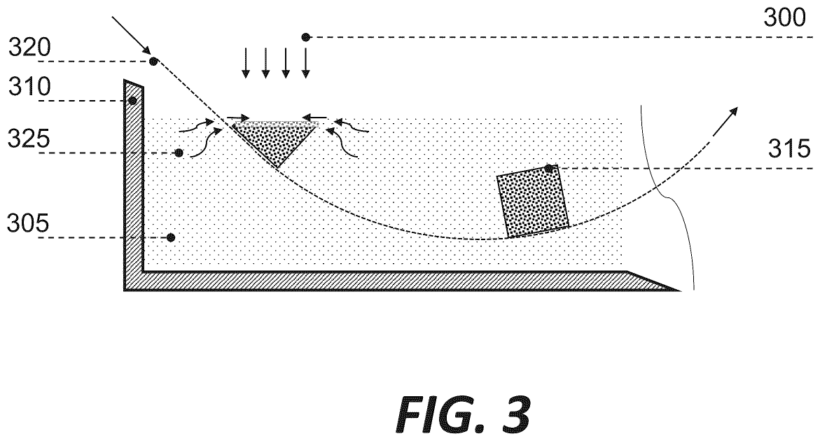

One potential limitation of the top-down and bottom-up systems described herein thus far is that they require resetting the print stage after each article is printed and are not continuous processes. In contrast, FIG. 3 shows an example of a system for printing on a pliable substrate. Here, the pliable substrate can be moved through a vat of the photo-curable resin in a continuous manner while article(s) are printed onto the substrate. UV radiation 300 can be projected onto a surface of a volume of photo-curable resin 305 in a container 310 that is exposed to air. The printed article 315 can be printed onto a pliable substrate 320 that is moved through the photo-curable resin. In some cases, if the printing is continuous, a recoating mechanism is not used and recoating 325 proceeds without mechanical assistance.

The 3D printing systems described above can be used to print a variety of articles having fine features. The shape of the article and its properties, such as the resolution of fine features, the consistency and extent of cure of the resin can be determined by a combination of many factors, including, for example, the mechanical attributes of the system, the chemical attributes of the resin, and the printing methodology. In an aspect, the present disclosure relates to the printing methodology which can include how the article is supported throughout the printing process.

One printing methodology includes computationally “slicing” a geometric model of the 3D object to be printed into a series of layers that nominally constitute the 3D object when printed in succession. This process can be referred to as “rasterization” and printing of “rasterization data”. Further details about the digitization of a design and operation of a 3D printer suitable for production of the textiles described herein can be found in PCT Patent Application Serial No. PCT/US2021/023962, which is incorporated by reference herein in its entirety for all purposes.

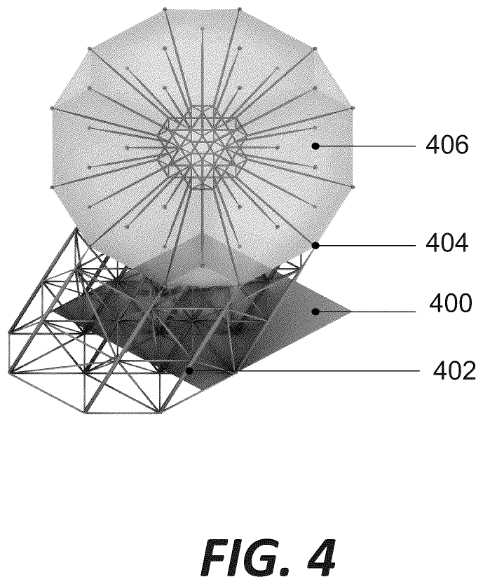

The support systems described herein may include multiple main components. For example, with reference to FIG. 4, components of a support system can include the support surface 400, support pillars 402, breakpoints 404, and the 3D printed article 406. The support surface may include a substrate, a machined part, and/or or a printed structure. A support pillar may be used to connect a support surface to a 3D printed article, and/or used to connect a 3D printed article to an adjacent 3D printed article. Support pillars can be braced, where a support pillar is connected to an adjacent support pillar. A breakpoint can be found at the end of a support pillar. A breakpoint can be designed to have a tapered tip, a ball tip, a uniform tip, or any combination thereof.

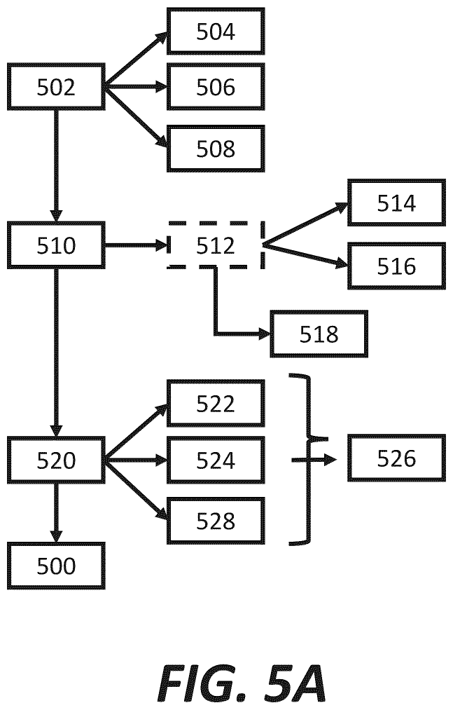

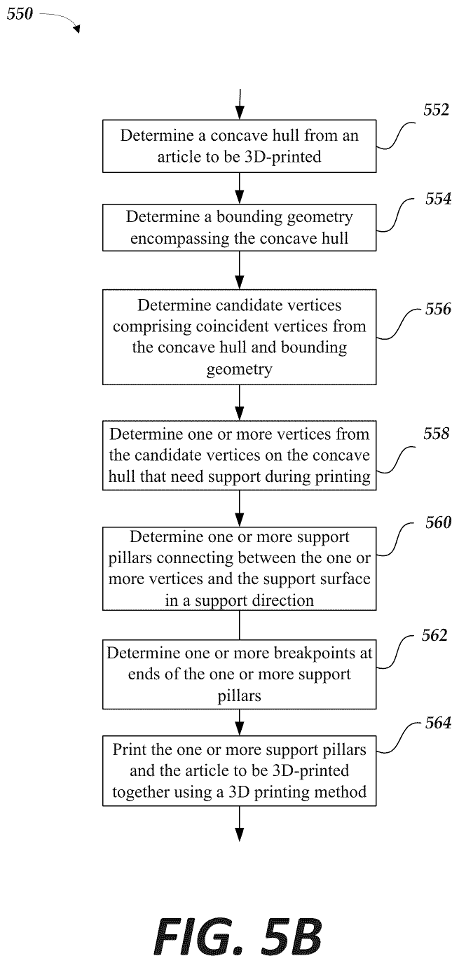

FIG. 5A provides a method for producing a supported 3D printed article 500 as described herein. First, the support surface 502 is defined, which can include the substrate 504, the printed structure 506, and optionally a machined part 508. Support pillars 510 can be identified, as well as braces 512 between the pillars and/or support surface. The braces can, without limitation, connect the support surface to the 3D article 514, connect the 3D article to other parts of the 3D article 516, and connect the support pillar to another support pillar 518. Finally, breakpoints 520 can be identified so that the printed article can be removed from the support following the printing process. The breakpoints can include tapered tips 522, ball tips 524, uniform tips 528, or any combination thereof (i.e., a combination tip 526).

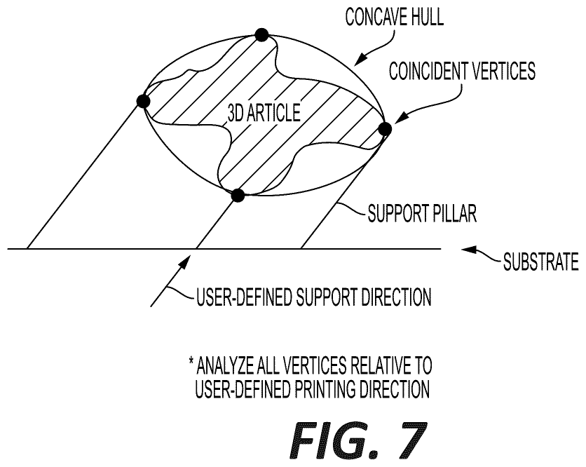

FIG. 5B is a flow chart of an example computerized method 550 for printing a supported 3D printed article, according to some embodiments. In some embodiments, method 550 may be executed to implement the method shown in FIG. 5A to produce a supported 3D-printed article. For example, method 550 may include determining a concave hull from an article to be 3D-printed, at act 552. In some embodiments, the article to be 3D-printed may include a plurality of fibers, which may define an outer concave hull (e.g., alpha shape). For example, the tips of the fibers may form a concave hull. Method 550 may proceed to determine a bounding geometry, at act 554. The bounding geometry may include a geometry with least area encompassing the concave hull as if the geometry is vacuum wrapped around the article to be 3D-printed. Method 550 may proceed with determining candidate vertices that are coincident vertices on the concave hull and on the bounding geometry, at act 556. FIG. 7 shows examples of a concave hull, bounding geometry and coincident vertices.

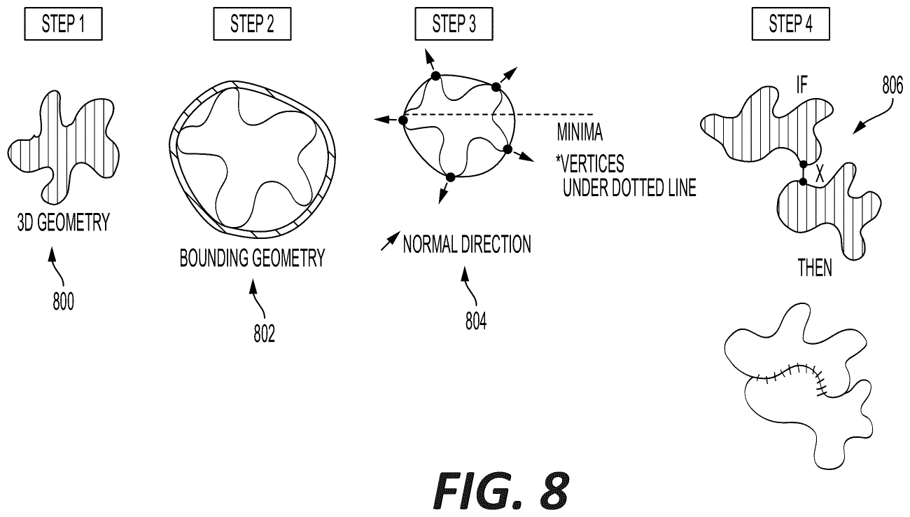

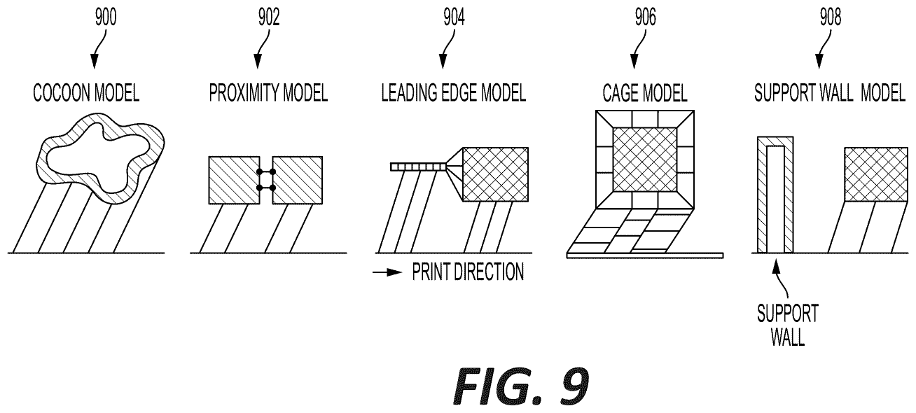

Returning to FIG. 5B, the candidate vertices may be analyzed with respect to a support direction and other parameters as will be further described herein. In some embodiments, support direction may indicate the direction of support, e.g., the orientation of support pillars. In some embodiments, the support direction may be perpendicular to the resin level during printing. In other words, the support direction may be the same as the print direction, e.g., in a DLP process. In some embodiments, the support direction may be different from the print direction. For example, the support direction and the print direction may be at 45 degrees to each other. Method 550 may proceed to determine whether one or more vertices of the candidate vertices need support, at act 558; determine one or more support pillars for connecting the one or more vertices that need support and a support surface at act 560; and print the one or more support pillars and the article to be 3D-printed together using a 3D printing method, at act 564. Various acts 552-564 are further described in detail with reference to FIGS. 8-9.

FIG. 8 shows an example a schematic illustration of principal steps for determining a support structure for a printed article, such as method 550 (FIG. 5B). As shown in FIG. 8, the geometry of the 3D article 800 is defined (e.g., at act 552 in FIG. 5B). In some embodiments, the 3D article may include a plurality of fibers that are each represented by a respective line object in a digital file. An example of digital file, e.g., .meso file, can be found in PCT Patent Application Serial No. PCT/US2021/023962, which is incorporated by reference herein in its entirety for all purposes. In some embodiments, the geometry of the fibers may define a concave hull (alpha shape), as shown. A bounding geometry 802 may be generated (e.g., at act 554 in FIG. 5B). As shown, bounding geometry 802 encompasses the concave hull of the 3D article such that all concave sets of a 3D printed article are combined within Euclidean space, as if the shape is vacuum wrapped by the bounding geometry. As shown, bounding geometry may be convex. Next, coincident vertices 804 are determined (e.g., at act 556 in FIG. 5B). These coincident vertices are candidate vertices and are further analyzed to determine whether one or more vertices need support during printing.

With further reference to FIG. 8, in some embodiments, the candidate vertices (e.g., 804) are further analyzed against one or more criteria and one or more vertices of the candidate vertices are determined to need support if one or more criteria are met (e.g., at act 558). In some embodiments, the one or more criteria may include a degree of alignment of a normal vector (of a vertex being evaluated) with the support direction. If the normal vector is facing the support surface and aligned with the support direction to a certain degree, then the candidate vertex is determined to need support. In some embodiments, a dot product may be used to represent the degree of alignment between a normal vector of a candidate vertex and the support direction. In some embodiments, the dot product between the normal vector and the support direction may be unitized (normalized) such that the dot product may have a value between −1 and 1.

As shown in FIG. 8, each candidate vertex is associated with a normal vector that is normal to the concave hull surface. A support direction is provided that extends from a support surface (e.g., a substrate below the 3D printed article) to the 3D printed article. In such case, a normal vector facing the support surface may correspond to an alignment with a direction opposite the support direction. In non-limiting examples, a dot product value of −1 (negative one) may indicate that the normal vector is perfectly aligned with the opposite of the support direction. In some embodiments, the criterion regarding the degree of alignment may include a threshold value (e.g., −0.5) below which the vertex being evaluated may be determined to need support. It is appreciated that other suitable methods can be used to measure the degree of alignment and thus, a suitable threshold can be selected or determined empirically. For example, in lieu of calculating dot products for candidate vertices, a degree of overhang of the 3D-printed article with respect to the support direction may be calculated.

Additionally, and/or alternatively, the one or more criteria that are used in determining whether a candidate vertex needs support may also include whether the candidate vertex is a minima point (relative minima) on the concave hull with respect to the support surface and the support direction. Responsive to determining that the candidate vertex on the concave hull is a minima point, the candidate vertex may be determined to need support during printing. As shown in FIG. 8, minima points (shown below the dotted line) are relative minima in a local area on the concave hull around the location (x*) of the candidate vertex such that f(x*)≤f(x) for all x in X within distance ε of x*, where X stands for the set of points on the concave hull.

Additionally, and/or alternatively, the one or more criteria that are used in determining whether a candidate vertex needs support may also include whether the candidate vertex is adjacent to another vertex that is already determined to need support. For example, a distance between a candidate vertex and a closest vertex on the concave hull (that is determined to need support) may be evaluated against a threshold distance. If the distance between the two vertices is above the threshold distance, the candidate vertex may be determined to need support during printing.

Additionally, and/or alternatively, the one or more criteria that are used in determining whether a candidate vertex needs support may include whether the candidate vertex is an end of a fiber. This criterion may be represented by a valency value, which may be calculated and evaluated against a threshold value. For example, the article to be 3D-printed may be represented by a plurality of line objects each comprising a plurality of connected nodes in a digital file. An example of digital file (e.g., meso file) can be found in PCT Patent Application Serial No. PCT/US2021/023962, which is incorporated by reference herein in its entirety for all purposes. Valency may represent a number of neighbor nodes to which the candidate vertex (node) is connected in a line object. Thus, the end of a fiber may have a valency value of 1, whereas a node that is not an end of a fiber may have a valency value of larger than one. As such, a valency of a candidate vertex below a threshold valency (e.g., one or less) may indicate that the candidate vertex may be an end of a fiber that has no support or a point that connects to no other nodes to get support, and thus, may need support.

Returning to FIG. 5B, act 560 determines one or more support pillars for connecting the one or more vertices that need support and a support surface. In doing so, a respective support pillar may be determined to extend from each of the one or more vertices that are determined to need support to the support surface along the support direction. For example, the support surface may be a substrate, and the support pillars may extend from respective one or more vertices to the substrate (see FIG. 7).

In some embodiments, the support surface may be another 3D-printed article within a proximity from which the article to be 3D-printed may draw support. For example, when a distance (e.g., in Euclidean space) between the article to be 3D-printed and another article to be 3D-printed is determined to be below a threshold distance (see FIG. 8, 806), the two 3D-printed articles may be translated relative to each other such that vertices on the 3D-printed article where valency is less than one may become coincident with vertices on the other 3D-printed article (as shown in FIG. 8, at 806). This ensures that there is no tiny gap between the objects where it may be separated and fall apart during printing. Additionally, and/or alternatively, the two 3D-printed articles may be connected via one or more support pillars (as shown in FIG. 9, at 902), which may be determined to be disposed (and printed) between the two 3D-printed articles in a similar manner as the one or more pillars are determined (such as described in FIG. 7), except that the support surface is another 3D-printed article instead of a substrate. In some embodiments, given that there might be a significant number of vertices within a small region, the number of support pillars may be limited in that two adjacent support pillars must be at a distance exceeding a minimal allowed distance. The minimal allowed distance between two support pillars may be user defined or determined empirically.

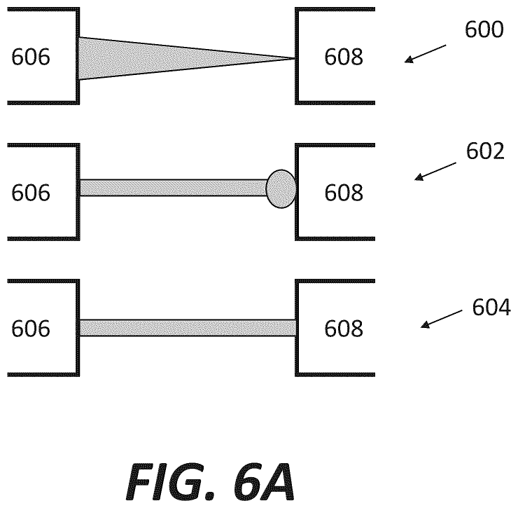

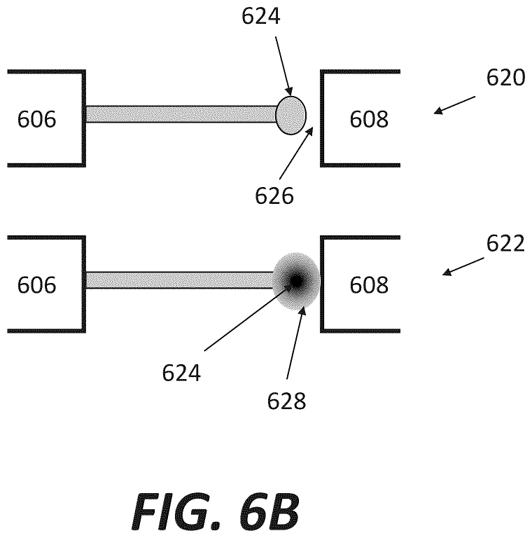

With further reference to FIG. 5B, method 550 may include determining one or more breakpoints at ends of the one of the one or more support pillars, at act 562. Whereas the one or more support pillars are connected to the 3D-printed article, the breakpoints enable the support pillars to be severed (e.g., by snapping) from the 3D-printed article after the article is 3D-printed. In some embodiments, the breakpoints may be configured in various manners to enable severing from the 3D-printed article. For example, as shown in FIG. 6A, a breakpoint may include a tapered tip (600), a ball tip (602), or a uniform tip (604). In each case, the breakpoint connects a first 3D geometry 606 or portion thereof to a second 3D geometry 608 or portion thereof, where the second 3D geometry 608 may be severed from the support pillars retaining any of the support member after being severed at the breakpoint. In a non-limiting example, the tapered pillar structure (600) may be used in any suitable 3D printing, such as in resin-base systems, to create removable support structures. The taper tip creates intended weak point between the printed article and support structure for improved ease of removal. In a non-limiting example, a ball tip (602) for a support pillar may achieve minimal contact with the print article, thus resulting in minimal residue/mark on the surface of the printed article. In contrast, a breakpoint that is in contact with the 3D-printed article in a larger area may result in residue or an obvious mark of snapped pillar as fracture of the material could be unpredictable.

FIG. 6B shows an example of a variation of a ball breakpoint before and after being (partially) cured, according to some embodiments, where the ball breakpoint may be used to even further reduce the residue or the mark on the surface of the 3D-printed article after being severed from the support. In some embodiments, the location of the breakpoint 624 may result in a non-contact, leaving a gap 626 between the breakpoint and the article to be 3D-printed 608 in 3D model space and slice images (comparing configuration 620 in FIG. 6B with 602 in FIG. 6A).

In some embodiments, in some printing methods (e.g., SLA), the curing of the material during printing may be controlled such that the breakpoint is partially cured, where the partially cured material (e.g., resin) may grow around the breakpoint to be in contact with the 3D-printed article (see state 622, in which the gap 626 is filled by the partially cured material 628) to provide support for the 3D-printed article. One of the characteristics of the curing dynamics of photopolymer include: as UV dosage increases, nucleation of cure resin will grow in both Z direction (parallel to light projection) and XY direction (perpendicular to light projection). As resin cures, it transitions from a liquid to a gel, then to the solidified resin, as UV dosage of an area progressively increases. The amount of UV dosage around each pixel can be configured to control the growth size of the nucleation and formation of gel on its perimeter. In the case of the ball breakpoint, the ball tip will continuously grow until the gel interface makes contact with the printed article. The gel will provide mechanical linkages between the printed article and support pillar. Because the gel has low tensile strength, it can be removed easily from the surface of the 3D-printed article when being severed from the support. Further, the gel may be more susceptible to solvent attack, which makes it relatively soluble thus washable with a suitable solvent (e.g., IPA) during post processing. By washing off the gel contact point, a residue free support can be achieved.

Although FIGS. 6A-6B show variations of breakpoints at ends of the support pillars, it is appreciated the one or more support pillars are not limited to any single breakpoint type. For example, not all of the breakpoints for the one or more support pillars need to be of the same type, and different support pillars may include different types of breakpoints at the ends.

The various embodiments as described above with respect to FIGS. 1-8 may be applied to 3D printing of articles in various configurations as shown in FIG. 9. In some embodiments, an intermediate support structure comprising a cocoon model 900 can be utilized when there are an overwhelming large (user-defined) number of vertices with valency being equal to 1, and/or the dot product of the normal vector for the majority of the 3D printed part being equal to 0 (e.g., normal vector being perpendicular to the support direction). This means that the support pillars such as those described above (see FIG. 7) may not provide sufficient support due to the particular configuration of the 3D-printed article. In such case, an intermediate support structure is needed. The cocoon model may be configured to surround the 3D-printed article and connect the 3D-printed article. Thus, determining the one or more support pillars for connecting the one or more vertices on the concave hull of the article to be 3D-printed to the support surface may include determining the one or more support pillars for connecting vertices on the cocoon model to the support surface. The cocoon model is printed together with printing the one or more support pillars and the 3D-printed article.

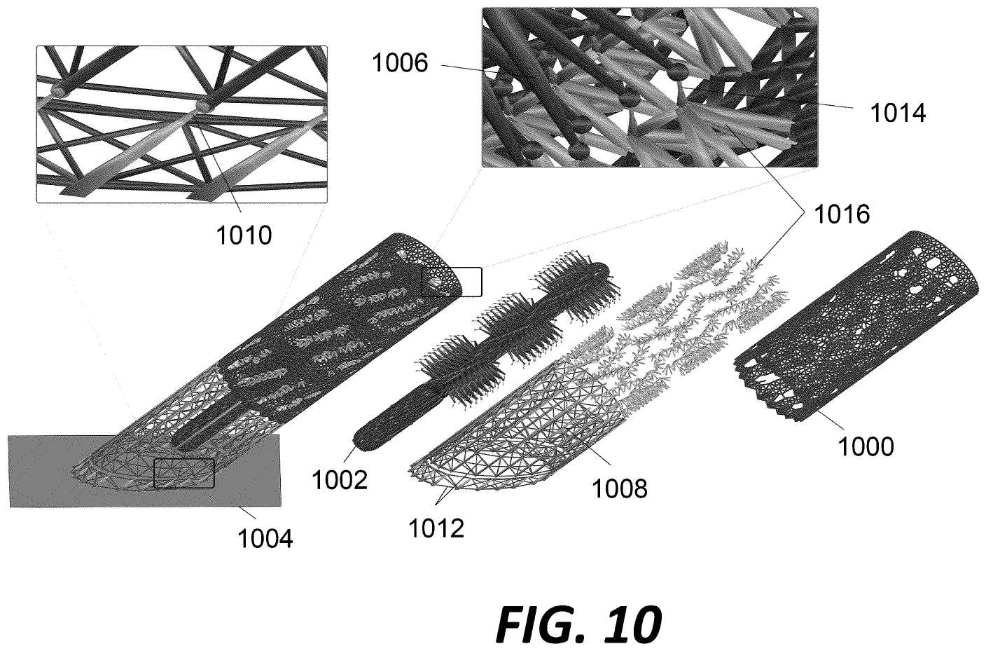

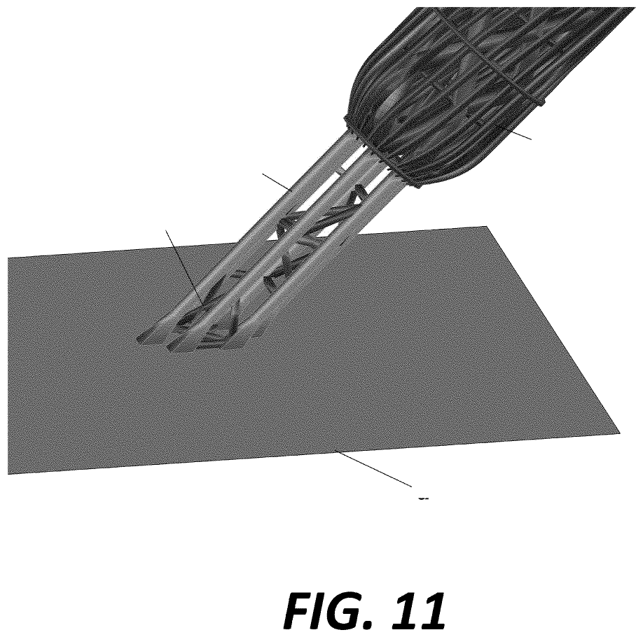

FIGS. 10-11 show examples of a cocoon model being used to support a 3D printed mascara brush using the systems and methods described herein. A combination of two support strategies may be used to enhance printing quality, simplify post processing, and optimize throughput. With reference to FIG. 10, the main part of the cocoon support is the printed mesh-like support surface 1000 surrounding the brush geometry 1002. It provides a secondary surface between the substrate 1004 and the bristles 1006 of the brush, connected with two groups of braced support pillars. The support pillars 1008 between the substrate and the support surface secure the cocoon to the substrate. Near the bottom of the support pillars, breakpoints 1010 are introduced to make the upper support detachable from the substrate. The brace pillars 1012 are added in between the support pillars to reinforce the support structure. The breakpoints 1014 are also applied to the end of the second group of support pillars 1016 close to the tips of the bristles, which will also detach after the printing process. FIG. 11 shows another schematic drawing of a supported mascara brush associated with the substrate.

Returning to FIG. 9, in some embodiments, a leading-edge model 904 can be utilized when a 3D printed article requires additional stability at the beginning of a print, and may ensure precision when multiple external forces are at play during the printing process. For example, when the resin level and print direction are not aligned (e.g., an angle between the resin level in printing and the print direction is at or above 45 degrees), the leading-edge model may be needed. As shown, a leading portion connecting to the article to be 3D-printed may be determined, where the leading portion may be configured to be elevated from the support surface. One or more additional support pillars for connecting the leading portion to the support surface may be determined and printed together with printing the one or more support pillars and the 3D-printed article.

With further reference to FIG. 9, in some embodiments, a support wall model 908 may be utilized when a user requires controlled resin flow during printing. Support walls may be placed strategically to protect 3D printed parts from being damaged. As shown, the support wall may connect and extend perpendicularly from the support surface, and is adjacent to the article to be 3D-printed. The support wall may be printed together with printing the one or more support pillars and the 3D-printed article.

With further reference to FIG. 9, in some embodiments, an intermediate support structure comprising a cage model 906 may be utilized when a majority of vertices of the concave hull defined by the 3D-printed article need support (e.g., the dot products of a majority of normal vectors in a single 3D printed part are less than 0). The cage model may also be utilized when a user requires additional stability when stacking multiple adjacent 3D printed parts within a defined printable area. As shown, the cage may be configured to surround the article to be 3D-printed and connect to the 3D-printed article via one or more additional support pillars. Thus, determining the one or more support pillars for connecting the vertices that need support to the support surface may include determining the one or more support pillars for connecting the intermediate support structure to the support surface. The cage and the one or more additional support pillars may be printed together with printing the one or more support pillars and the 3D-printed article.

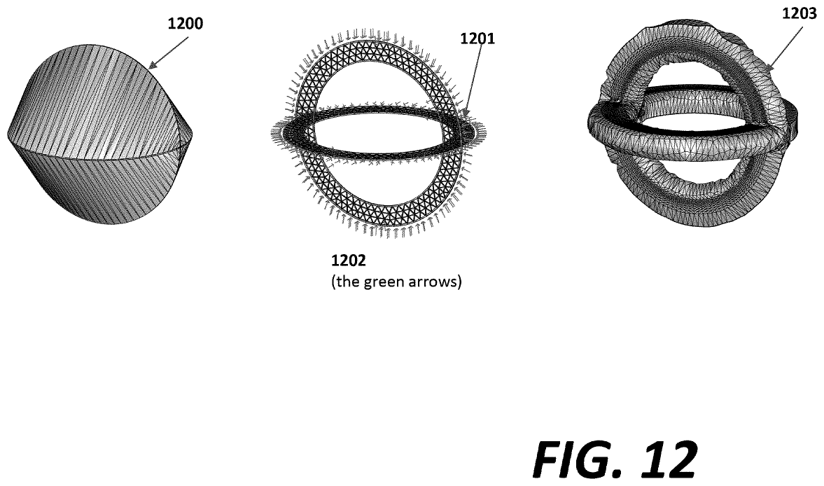

In some embodiments, the cage model 906 may be configured as a tetrahedral plate support, as will be described in detail with respect to FIGS. 12-14. Although various printing models are shown in FIG. 9, it is appreciated that these various printing models and strategies may be combined in any suitable manner. For example, a cocoon model may be used in combination with a wall model or a leading edge model. Other suitable combinations may be possible.

With reference to FIGS. 12-14, in some embodiments, a tetrahedral plate support may be designed to balance the forces that are expected to be felt upon a printed article, during or after the printing process, e.g., in order to stabilize against those forces such that the shape of the article is not distorted. During printing, the tetrahedral support can achieve a more accurate shape of the printed article by adding solid constraints. This can allow for clean stacking for mass production. In post-printing production steps, the tetrahedral plate can reduce shrinkage and distortion, allow easier handling (e.g., by providing a clamp area for metallization or powdering), and allow easier tooling (e.g., by registration to other shapes or solid parts and interfacing with testing equipment). During packaging, the tetrahedral plate support can improve packaging internally (e.g., by embedding a code onto the support structure) or externally (e.g., by functioning as a part of the packaging itself and providing protection during transportation).

The tetrahedral plate support can have certain properties. It can be torsion resistant (e.g., a tetrahedron solid is high-triangulated thus provides high rigidity). A thick line diameter can be assigned to the tetrahedral plate structures in the digital file that directs the 3D printer (e.g., meso file as described above). The porous nature of the tetrahedral plate support can improve printability and washability of the printed article. Furthermore, the tetrahedral plate support can provide a reaction force given an anticipated distortion tensor field.

In some embodiments, the tetrahedral plate support may be used if the generated concave hull is valid (e.g., the plurality of fibers in a 3D-printed article define a concave hull that is manifold and solid). The tetrahedral plate may be applicable if most of the plate support pillar has a relative short length that does not cause severe overhang during printing. In some cases, the amount of distortion of the main body implies the distortion force is applied. In some cases, the sampling rate of the distortion tensor field should be within the similar range of the alpha value of the concave hull.

With reference to FIG. 12, input constraints to the design of the tetrahedral plate support can be determined. Here, a concave hull 1200 can be constructed from points on the main body 1201. In some cases, the main body includes points of the article to be produced. A distortion tensor field 1202 can be calculated or simulated. Furthermore, an area of avoidance 1203 for the support structures to avoid can be determined. These input constraints can be used in a method for calculating an appropriate geometry for supporting the article to be printed using tetrahedral plates.

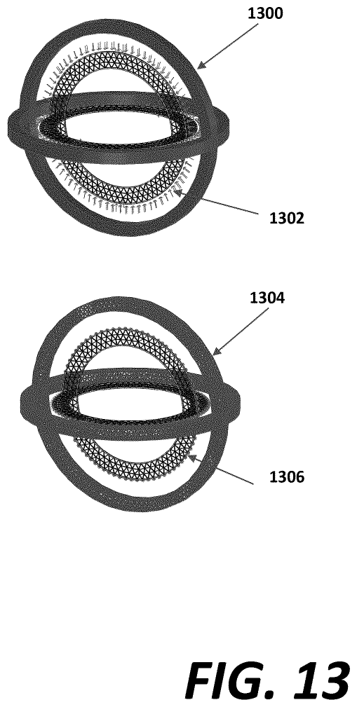

Turning to FIG. 13, those steps include offsetting the concave hull by a chosen distance and utilizing a topological optimization method to generate the shape of the tetrahedral plate 1300. This shape can be based on the offset concave hull and the support and load boundary conditions 1302 (i.e., distortion tensor field). As an alternative to the topological optimization method, the avoidance area may be used as a guide input to remove the faces from the offset concave hull. The shape can be discretized to get the tetrahedral mesh 1304 based on a given density (mesh edge length). Then the locations of the points from the main body that need supported (e.g., 1306) can be determined, for example, using the method described above.

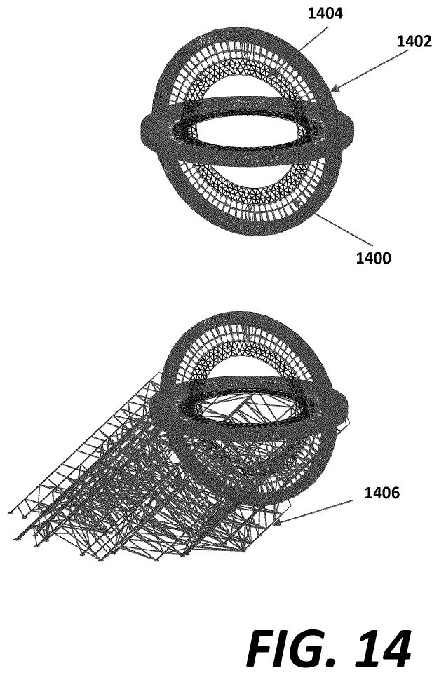

Continuing with FIG. 14, plate support pillars 1400 are line elements that connect the tetrahedral plate 1402 to the main body 1404. The tensor field can be sampled at the given locations of the points that need supported and calculate the direction of the reaction force to resist such tensor. For each point that needs support, the closest point on the tetrahedral plate along the calculated vector may be found. The sampled value may be re-mapped to a pre-determined range to get a set of graded diameter values. This creates regions of different element diameters, thus stiffness in response to the stress forces at local regions according to needs. Finally, support pillar 1406, with the start and end points, may be generated and each support pillar may be assigned a corresponding diameter.

It should be appreciated that one or more 3D printing systems may be used to implement the methods described herein. For example, some embodiments may be used in conjunction with one or more systems described in U.S. Pat. No. 11,104,060, filed Aug. 27, 2019, which is incorporated by reference herein in its entirety. However, it should be appreciated that other printer methods and systems may be used with embodiments as described herein.

The geometry of the article to be printed can be digitally represented in any suitable file structure (e.g., for use in controlling the 3D printer). Such systems can include slicing the geometry into a plurality of layers, e.g., as described in U.S. Pat. No. 11,681,269, filed Mar. 24, 2021, which is incorporated by reference herein in its entirety. Such systems, methods, and file formats can be suitable for printing microstructures.

The various embodiments described in FIGS. 1-14 provide advantages over conventional 3D printing systems and methods. For example, convention methods generate a support from vertices that have a valency of less than 1. The systems and methods described herein use a bounding geometry such that crucial geometrical data is simplified, which reduces overall computation and analysis time. For example, the analysis/determination of support is based on information of the concave hull. By definition, a concave hull always contains same or fewer vertices than the set of points it contains. In applications such as printing fibers, where the print article is made up of thousands of individual line elements, it may contain thousands or millions of vertices. By creating a concave hull, the line element/vertices that are not on the deep interior of the print article may be ignored. This is assuming these interior vertices do not need to be supported, which are usually true (e.g., a lattice structure only needs to be supported from the outside and all interior line element are printable with support).

Further, collision detection between line elements, which is computationally intensive, can be avoided. Since the support pillar always initiate from the surface of the concave hull, only detection of whether a line intersects with a single concave hull is needed, rather than checking the distance to thousands of line elements, for each line segment and for every single support pillar.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present disclosure.

Various aspects of the present disclosure may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications, improvements, and/or combinations of embodiments described herein will readily occur to those skilled in the art. Such modifications, improvements, and combinations are intended to be within the spirit and scope of the invention. Accordingly, the foregoing description is by way of example only, and is not intended as limiting. The invention is limited only as defined by the following claims and the equivalents thereto.

Various aspects are described in this disclosure, which include, but are not limited to, the following aspects:

(1) A supported 3D-printed article, comprising: a 3D-printed article comprising a plurality of fibers; a support surface; and one or more support pillars connecting the 3D-printed article to the support surface to provide support for the 3D-printed article; wherein the 3D-printed article defines a concave hull, the concave hull comprising one or more vertices thereon respectively connecting the one or more support pillars.

(2) The supported 3D-printed article of aspect 1, wherein the 3D-printed article comprises any of textiles, feathers, fur, brushes, foams, any other fibrous or finely-featured object, or a combination thereof.

(3) The supported 3D-printed article of aspect 1 or 2, wherein: each of the one or more vertices defines a respective vector normal to the concave hull; and a dot product of the respective vector and a support direction in which the supported 3D-printed article was printed is below a threshold.

(4) The supported 3D-printed article of aspect 3, wherein each of the one or more vertices is a minima point of the concave hull with respect to the support surface and the support direction.

(5) The supported 3D-printed article of any of aspects 1-4, wherein each of the one or more vertices is a tip of a respective one of the plurality of fibers of the 3D-printed article.

(6) The supported 3D-printed article of any of aspects 1-5, further comprising one or more braces connecting the one or more support pillars.

(7) The supported 3D-printed article of any of aspects 1-6, further comprising one or more breakpoints at ends of the one or more support pillars such that the one or more support pillars and the 3D-printed article are severable at the one or more breakpoints.

(8) The supported 3D-printed article of aspect 7, wherein a breakpoint of the one or more breakpoints comprises one of a tapered tip, a ball tip, or a uniform tip.

(9) The supported 3D-printed article of aspect 8, wherein the breakpoint comprises a ball tip in non-contact with and coupled to the 3D-printed article via a material having a degree of cure different from a degree of cure of the ball tip, wherein the material is formed by nucleation during curing of resin in the breakpoint.

(10) The supported 3D-printed article of aspect 9, wherein the material comprises a gel.

(11) The supported 3D-printed article of any of aspects 1-10, further comprising: another 3D-printed article connected to the 3D-printed article via one or more first additional support pillars; and one or more second additional support pillars connecting the another 3D-printed article to the support surface.

(12) The supported 3D-printed article of aspect 11, further comprising one or more breakpoints at ends of the one or more first additional support pillars such that the 3D-printed article and the another 3D-printed article are severable at the one or more breakpoints.

(13) The supported 3D-printed article of any of aspects 1-12, wherein: the 3D-printed article comprises a 3D-printed object and an intermediate support structure comprising a cocoon surrounding the 3D-printed object, the intermediate support structure connecting to the 3D-printed article; and the one or more support pillars connect the intermediate support structure to the support surface to provide support to the 3D-printed article.

(14) The supported 3D-printed article of any of aspects 1-13, further comprising: (a) a leading portion connecting to the 3D-printed article and elevated from the support surface; and (b) one or more additional support pillars connecting the leading portion to the support surface; wherein the supported 3D-printed article is printed in a print direction, wherein an angle between a resin level in printing the supported 3D-printed article and the print direction is at or above 45 degrees.

(15) The supported 3D-printed article of any of aspects 1-14, wherein: (a) the 3D-printed article comprises a 3D-printed object and an intermediate support structure comprising a cage surrounding the 3D-printed object, the intermediate support structure coupled to the 3D-printed article via one or more additional support pillars connecting the 3D-printed object to the intermediate support structure; and (b) the one or more support pillars connect the intermediate support structure to the support surface to provide support for the 3D-printed article.

(16) The supported 3D-printed article of aspect 15, wherein the intermediate support structure comprises a tetrahedral plate.

(17) The supported 3D-printed article of any of aspects 1-16, further comprising: a support wall connecting and extending perpendicularly from the support surface, wherein the support wall is adjacent to the 3D-printed article.

(18) A method for producing a supported 3D-printed article, the method comprising: determining a concave hull from an article to be 3D-printed, wherein the article to be 3D-printed comprises a plurality of fibers; determining one or more support pillars for connecting the article to be 3D-printed and a support surface; and printing the one or more support pillars and the article to be 3D-printed together using a 3D printing method.

(19) The method of aspect 18, wherein determining the one or more support pillars comprises: determining one or more vertices on the concave hull that need support during printing; wherein the one or more support pillars connect between the one or more vertices and the support surface in a support direction.

(20) The method of aspect 19, wherein determining the one or more vertices on the concave hull that need support comprises, for a point on the concave hull: (a) determining a vector normal to the concave hull; determining a dot product of the vector and the support direction; (b) determining whether the dot product is below a threshold; and (c) responsive to determining that the dot product is below a threshold: determining the point to be a vertex that needs support; otherwise determining that the point is not a vertex that needs support.

(21) The method of aspect 19 or 20, wherein determining the one or more vertices on the concave hull that need support comprises, for a point on the concave hull: (a) determining whether the point on the concave hull is a minima point with respect to the support surface and the support direction; and (b) responsive to determining that the point on the concave hull is a minima point: determining the point to be a vertex that needs support; otherwise determining that the point is not a vertex that needs support.

(22) The method of any of aspects 19-21, wherein: the article to be 3D-printed is represented by a plurality of line objects each comprising a plurality of connected nodes; and determining the one or more vertices on the concave hull that need support comprises, for a point on the concave hull: (a) determining a valency for the point, the valency representing a number of neighbor nodes to which the point is connected in a line object; (b) determining whether the valency is below a threshold valency; and (c) responsive to determining that the valency is below the threshold valency: determining the point to be a vertex that needs support; otherwise determining that the point is not a vertex that needs support.

(23) The method of any of aspects 19-22, wherein determining the one or more vertices on the concave hull that need support further comprises, for a point on the concave hull: (a) determining whether a distance between the point and a closest vertex on the concave hull is above a threshold distance; and (b) responsive to determining that the distance above the threshold distance: determining the point to be a vertex that needs support; otherwise, determining that the point is not a vertex that needs support.

(24) The method of any of aspects 19-23, further comprising: determining a bounding geometry comprising a geometry with least area encompassing the concave hull as if the geometry is vacuum wrapped around the article to be 3D-printed; and determining candidate vertices that are on the concave hull and that are coincident with vertices on the bounding geometry; wherein determining the one or more vertices on the concave hull that need support comprises determining the one or more vertices from the candidate vertices.

(25) The method of any of aspects 18-24, further comprising severing the one or more support pillars from the article to be 3D-printed after the article is 3D-printed.

(26) The method of any of aspects 18-25, further comprising determining one or more breakpoints at ends of the one of the one or more support pillars connecting the one or more support pillars and the article to be 3D-printed, wherein the one or more support pillars and the 3D-printed article are severable at the one or more breakpoints.

(27) The method of aspect 26, further comprising determining each of the one or more breakpoints to be a tapered tip, a ball tip, or a uniform tip.

(28) The method of aspect 27, wherein determining each of the one or more breakpoints comprises: determining a breakpoint of the one or more breakpoints to be a ball tip; and determining a location of the breakpoint that results in a gap between the breakpoint and the article to be 3D-printed.

(29) The method of aspect 28, further comprising performing partial curing of resin after the article is 3D-printed such that the partially cured resin in the breakpoint grows to contact the 3D-printed article.

(30) The method of aspect 29, wherein the partially cured resin is a gel.

(31) The method of any of aspects 18-30, further comprising: responsive to determining that a distance between the article to be 3D-printed and another article to be 3D-printed is below a threshold distance: (a) determining one or more additional support pillars to connect between the article to be 3D-printed and the another article to be 3D-printed; and (b) printing the another article and the one or more additional support pillars together with printing the one or more support pillars and the 3D-printed article.

(32) The method of any of aspects 18-31, further comprising: determining an intermediate support structure comprising a cocoon surrounding and connecting to the article to be 3D-printed; and printing the intermediate support structure together with printing the one or more support pillars and the 3D-printed article; wherein determining the one or more support pillars for connecting the article to be 3D-printed to the support surface comprises determining the one or more support pillars for connecting the intermediate support structure to the support surface.

(33) The method of any of aspects 18-32, further comprising: determining a leading portion connecting to the article to be 3D-printed, the leading portion configured to be elevated from the support surface; determining one or more additional support pillars for connecting the leading portion to the support surface; and printing the one or more additional support pillars and the leading portion together with printing the one or more support pillars and the 3D-printed article; wherein the printing is performed in a print direction, wherein an angle between a resin level in printing and the print direction is at or above 45 degrees.

(34) The method of any of aspects 18-33, further comprising: determining an intermediate support structure comprising a cage surrounding the article to be 3D-printed; determining one or more additional support pillars for connecting the article to be 3D-printed to the intermediate support structure; and printing the intermediate support structure and the one or more additional support pillars together with printing the one or more support pillars and the 3D-printed article; wherein determining the one or more support pillars for connecting the article to be 3D-printed to the support surface comprises determining the one or more support pillars for connecting the intermediate support structure to the support surface.

(35) The method of aspect 34, wherein determining the intermediate support structure comprises determining a tetrahedral plate.

(36) The method of any of aspects 18-35, further comprising: determining a support wall connecting and extending perpendicularly from the support surface, wherein the support wall is adjacent to the article to be 3D-printed; and printing the support wall together with printing the one or more support pillars and the 3D-printed article.

(37) The method of any of aspects 18-36, wherein the 3D printing method comprises any of FDM/FFF, SLS, or SLA/DLP.

(38) A system for producing a supported 3D-printed article, the system comprising: a 3D printer; and one or more processors configured to: (a) determine a concave hull from an article to be 3D-printed, the article to be 3D-printed comprising a plurality of fibers; (b) determine one or more support pillars for connecting the article to be 3D-printed and a support surface based on the concave hull; and (c) cause the 3D printer to print the one or more support pillars and the article to be 3D-printed together using a 3D printing method.

(39) A method for determining a support structure for producing a supported 3D-printed article, the method comprising: determining a concave hull from an article to be 3D-printed, the article to be 3D-printed comprising a plurality of fibers; and determining one or more support pillars for connecting the article to be 3D-printed and a support surface based on the concave hull.

(40) A supported 3D-printed mascara brush comprising: a 3D-printed article comprising a plurality of bristles; a support surface; a cocoon support surrounding the plurality of bristles and connecting to the plurality of bristles via a plurality of first support pillars; and a plurality of second support pillars connecting the cocoon support and the support surface.

We claim:

1. A method for producing a supported 3D-printed article, the method comprising:
determining a concave hull from an article to be 3D-printed, wherein the article to be 3D-printed comprises a plurality of fibers;
determining one or more support pillars for connecting the article to be 3D-printed and a support surface; and
printing the one or more support pillars and the article to be 3D-printed together using a 3D printing method.

2. The method of claim 1, wherein determining the one or more support pillars comprises:
determining one or more vertices on the concave hull that need support during printing;
wherein the one or more support pillars connect between the one or more vertices and the support surface in a support direction.

3. The method of claim 2, wherein determining the one or more vertices on the concave hull that need support comprises, for a point on the concave hull:
determining a vector normal to the concave hull;
determining a dot product of the vector and the support direction;
determining whether the dot product is below a threshold; and
responsive to determining that the dot product is below a threshold:
determining the point to be a vertex that needs support; otherwise
determining that the point is not a vertex that needs support.

4. The method of claim 2, wherein determining the one or more vertices on the concave hull that need support comprises, for a point on the concave hull:
determining whether the point on the concave hull is a minima point with respect to the support surface and the support direction; and
responsive to determining that the point on the concave hull is a minima point:
determining the point to be a vertex that needs support; otherwise
determining that the point is not a vertex that needs support.

5. The method of claim 2, wherein:
the article to be 3D-printed is represented by a plurality of line objects each comprising a plurality of connected nodes; and
determining the one or more vertices on the concave hull that need support comprises, for a point on the concave hull:
determining a valency for the point, the valency representing a number of neighbor nodes to which the point is connected in a line object;
determining whether the valency is below a threshold valency; and
responsive to determining that the valency is below the threshold valency:
determining the point to be a vertex that needs support; otherwise
determining that the point is not a vertex that needs support.

6. The method of claim 2, wherein determining the one or more vertices on the concave hull that need support further comprises, for a point on the concave hull:
determining whether a distance between the point and a closest vertex on the concave hull is above a threshold distance; and
responsive to determining that the distance above the threshold distance:
determining the point to be a vertex that needs support; otherwise,
determining that the point is not a vertex that needs support.

7. The method of claim 2, further comprising:
determining a bounding geometry comprising a geometry with least area encompassing the concave hull as if the geometry is vacuum wrapped around the article to be 3D-printed; and
determining candidate vertices that are on the concave hull and that are coincident with vertices on the bounding geometry;
wherein determining the one or more vertices on the concave hull that need support comprises determining the one or more vertices from the candidate vertices.

8. The method of claim 1, further comprising severing the one or more support pillars from the article to be 3D-printed after the article is 3D-printed.

9. The method of claim 1, further comprising determining one or more breakpoints at ends of the one of the one or more support pillars connecting the one or more support pillars and the article to be 3D-printed, wherein the one or more support pillars and the 3D-printed article are severable at the one or more breakpoints.

10. The method of claim 9, further comprising determining each of the one or more breakpoints to be a tapered tip, a ball tip, or a uniform tip.

11. The method of claim 10, wherein determining each of the one or more breakpoints comprises:
determining a breakpoint of the one or more breakpoints to be a ball tip; and
determining a location of the breakpoint that results in a gap between the breakpoint and the article to be 3D-printed.

12. The method of claim 11, further comprising performing partial curing of resin after the article is 3D-printed such that the partially cured resin in the breakpoint grows to contact the 3D-printed article.

13. The method of claim 12, wherein the partially cured resin is a gel.

14. The method of claim 1, further comprising:
responsive to determining that a distance between the article to be 3D-printed and another article to be 3D-printed is below a threshold distance:
determining one or more additional support pillars to connect between the article to be 3D-printed and the another article to be 3D-printed; and
printing the another article and the one or more additional support pillars together with printing the one or more support pillars and the 3D-printed article.

15. The method of claim 1, further comprising:
determining an intermediate support structure comprising a cocoon surrounding and connecting to the article to be 3D-printed; and
printing the intermediate support structure together with printing the one or more support pillars and the 3D-printed article;
wherein determining the one or more support pillars for connecting the article to be 3D-printed to the support surface comprises determining the one or more support pillars for connecting the intermediate support structure to the support surface.

16. The method of claim 1, further comprising:
determining a leading portion connecting to the article to be 3D-printed, the leading portion configured to be elevated from the support surface;
determining one or more additional support pillars for connecting the leading portion to the support surface; and
printing the one or more additional support pillars and the leading portion together with printing the one or more support pillars and the 3D-printed article;
wherein the printing is performed in a print direction, wherein an angle between a resin level in printing and the print direction is at or above 45 degrees.

17. The method of claim 1, further comprising:
determining an intermediate support structure comprising a cage surrounding the article to be 3D-printed;
determining one or more additional support pillars for connecting the article to be 3D-printed to the intermediate support structure; and
printing the intermediate support structure and the one or more additional support pillars together with printing the one or more support pillars and the 3D-printed article;
wherein determining the one or more support pillars for connecting the article to be 3D-printed to the support surface comprises determining the one or more support pillars for connecting the intermediate support structure to the support surface.

18. The method of claim 17, wherein determining the intermediate support structure comprises determining a tetrahedral plate.

19. The method of claim 1, further comprising:
determining a support wall connecting and extending perpendicularly from the support surface, wherein the support wall is adjacent to the article to be 3D-printed; and
printing the support wall together with printing the one or more support pillars and the 3D-printed article.

20. The method of claim 1, wherein the 3D printing method comprises any of FDM/FFF, SLS, or SLA/DLP.

21. A supported 3D-printed article, comprising:
a 3D-printed article comprising a plurality of fibers;
a support surface; and
one or more support pillars connecting the 3D-printed article to the support surface to provide support for the 3D-printed article;
wherein the 3D-printed article defines a concave hull, the concave hull comprising one or more vertices thereon respectively connecting the one or more support pillars.

22. A system for producing a supported 3D-printed article, the system comprising:
a 3D printer; and
one or more processors configured to:
determine a concave hull from an article to be 3D-printed, the article to be 3D-printed comprising a plurality of fibers;
determine one or more support pillars for connecting the article to be 3D-printed and a support surface based on the concave hull; and
cause the 3D printer to print the one or more support pillars and the article to be 3D-printed together using a 3D printing method.

23. A method for determining a support structure for producing a supported 3D-printed article, the method comprising:
determining a concave hull from an article to be 3D-printed, the article to be 3D-printed comprising a plurality of fibers; and
determining one or more support pillars for connecting the article to be 3D-printed and a support surface based on the concave hull.

24. A supported 3D-printed mascara brush comprising:
a 3D-printed article comprising a plurality of bristles;
a support surface;
a cocoon support surrounding the plurality of bristles and connecting to the plurality of bristles via a plurality of first support pillars; and
a plurality of second support pillars connecting the cocoon support and the support surface.
